(19) United States
(12) Patent Application Publication
(10) Pub. No.: US 2019/0047040 A1
(43) Pub. Date: Feb. 14, 2019

(54) DEVICE FOR PRODUCING REINFORCEMENT CAGES

(71) Applicant: Apilion Machines + Services GmbH, Kehl am Rhein (DE)

(72) Inventor: Lothar Hartenbauer, Kehl am Rhein (DE)

(73) Assignee: Apilion Machines + Services GmbH, Kehl am Rhein (DE)

(21) Appl. No.: 16/125,663

(22) Filed: Sep. 8, 2018

Related U.S. Application Data
(63) Continuation-in-part of application No. PCT/EP2017/055756, filed on Mar. 10, 2017.

(30) Foreign Application Priority Data
Mar. 11, 2016 (DE) 10 2016 104 554.3

(51) Int. Cl. B21F 27/12; B23K 11/00

(52) U.S. Cl. CPC B21F 27/124; B23K 11/0086

(57) ABSTRACT

The present invention relates to a device for producing reinforcement cages having multiple longitudinal rods around which a wire, being welded to the longitudinal rods, runs, in particular for concrete tubes, wherein the device comprises a longitudinal rod guidance arrangement having multiple guidance elements and multiple radial guidances. To enable varying the shape of the cross-section of the reinforcement cage, the radial guides each comprise a spindle arrangement having at least one spindle, and at least two guidance element drives are provided which are configured to move one of the guidance elements each independently along the associated radial guidance.

### RELATED APPLICATIONS

The present application is based on and claims priority to international application no. PCT/EP2017/055756 filed Mar. 10, 2017 by Lothar Hartenbauer for “Device for producing reinforcement cages,” which in turn is based on and claims priority to German patent application no. 10 2016 104 554.3 filed Mar. 11, 2016 by Lothar Hartenbauer for “Vorrichtung zur Herstellung von Bewehrungskörben.”

### FIELD OF THE INVENTION

The present invention relates to devices for producing reinforcement cages.

### BACKGROUND OF THE INVENTION

The present invention relates to a device for producing reinforcement cages, in particular for concrete tubes, according to the preamble of patent claim 1, and to a longitudinal rod guidance arrangement according to patent claim 11.

In general, such devices are used to wind wire helically around multiple longitudinal rods and to weld it to the longitudinal rods so as to form reinforcement cages. Such devices are known from German Patent Nos. DE3422420, DE2946297, DE1752908, and DE1552159. These devices include a longitudinal rod guidance arrangement having multiple guidance elements by which the longitudinal rods are guided, a wire guidance arrangement, a longitudinal wire clamping arrangement, and a welding arrangement. The longitudinal rod guidance arrangement provides for the desired formation of the longitudinal rods relative to each other. The longitudinal wire clamping arrangement clamps the longitudinal rods at an end so that they may be pulled through the longitudinal rod guidance arrangement by relative linear translation of the longitudinal wire clamping arrangement in respect to the longitudinal rod guidance arrangement. The longitudinal wire clamping arrangement is provided at a clamping arrangement carriage. The relative linear translation of the longitudinal wire clamping arrangement in respect to the longitudinal rod guidance arrangement is caused by moving the clamping arrangement carriage. The wire guidance arrangement provides for the helical positioning of the wire on the longitudinal rods while these are pulled through the longitudinal rod guidance arrangement. The welding arrangement welds the wires to the longitudinal rods.

In general, concrete parts can resist very well to pushing loads while only very poorly to pulling loads. The reinforcement cages serve for absorbing the pulling loads which occur in the concrete parts. Concrete tubes regularly include a cylindrical tube portion at one end of which a sleeve extension is formed. Pulling loads usually occur laterally (left and right) on the outside of the cylindrical tube portion and on the top and on the bottom of the inside of the cylindrical tube portion. Therefore, for the cylindrical tube portion, a reinforcement cage having an elliptical cross-section is ideal which is disposed in the areas which are normally exposed to a pulling load. In the sleeve extension, the end of a connected tube is accommodated which pushes against the sleeve extension from the inside. Therefore, a pulling load occurs substantially uniformly on the outside of the sleeve extension so that for the sleeve extension a round cross-section of the reinforcement cage is ideal.

The devices which are known from the prior-art documents mentioned above allow to produce reinforcement cages having a round or not round (in particular elliptical) cross-section having increasing or decreasing diameter. However, none of these devices allows to produce a reinforcement cage which includes a portion having an elliptical cross-section and a portion having a round cross-section.

From DE 23 60 531 A 1 a device for producing reinforcement cages, in particular for concrete tubes, is known which allows to produce a reinforcement cage which includes a portion having an elliptical cross-section and a portion having a round cross-section. To this end, multiple adjustment rods are translated which are hinged to the guidance elements for the longitudinal rods of a reinforcement cage, defining the radial positions of these. The adjustment rods may be translated via a first transmission train by means of a first hydraulic cylinder and via a second transmission train by means of a second hydraulic cylinder. The first transmission train is formed so that by actuation of the first hydraulic cylinder the guidance elements can be translated by the same amount while the second transmission train is formed so that by actuation of the second hydraulic cylinder the guidance elements are translated by different amounts each. The translations by different amounts are provided by means of manually adjustable tappets which are mounted to the adjustment rods. The positions of the guidance elements are not determined unambiguously at all times due to the use of tappets. The shape and size of the reinforcement cage is further strongly restricted by the dimensions of the elements of the first and second transmission trains.

The object of the present invention is to create a device for producing reinforcement cages and an associated longitudinal rod guidance arrangement which allow to vary the shape of the cross-section of the reinforcement cage.

The object of the invention is solved by a device for producing reinforcement cages having the features of the characterising portion of patent claim 1 and by a longitudinal rod guidance arrangement having the features of the characterising portion of patent claim 11.

### SUMMARY OF THE INVENTION

The present invention relates to a device for producing reinforcement cages having multiple longitudinal rods around which a wire, being welded to the longitudinal rods, preferably helically, runs, in particular for concrete tubes, wherein the device comprises a longitudinal rod guidance arrangement having multiple guidance elements and multiple radial guidances so as to guide one of the guidance elements each, wherein the radial guidances each comprise a spindle arrangement having at least one spindle, and wherein at least two guidance element drives are provided which are configured to move one of the guidance elements each independently along the associated radial guidance. In the context of the present invention, a spindle is preferably a threaded spindle, and a spindle arrangement is an arrangement comprising at least one spindle. The spindles are preferably mounted to the longitudinal rod guidance arrangement, more preferably either mounted rotatably to the longitudinal rod guidance arrangement (preferably rotatably supported in the longitudinal rod guidance arrangement) or mounted rotationally fixed to the longitudinal rod guidance arrangement. Preferably, one or more guidance columns are provided, each of which being led through a guidance element. Preferably, the guidance element drives are each configured to hold the associated guidance element in a position after moving. Advantageously, the position of the guidance element drives is determined exactly at all times. Preferably, for each guidance element a guidance element drive is provided which is configured to move one of the guidance elements each independently along the associated radial guidance. The longitudinal rod guidance arrangement provides for the desired relative formation of the longitudinal rods relative to each other. Preferably, the longitudinal rod guidance arrangement is rotatable around an axis. Preferably, the radial guidances are implemented so that the guidance elements have at least one radial component of movement when they are guided along the associated radial guidance. Preferably, each of the radial guidances (i.e. a path on which the associated guidance element is forced on by the associated radial guidance) extends along a line, wherein each of these lines has a tangent, wherein all of these tangents are in one plane and intersect in a point through which preferably the rotational axis of the longitudinal rod guidance passes, wherein the rotational axis is preferably perpendicular to the plane. Preferably, the lines are straight lines or include a straight portion which is touched by the associated tangent. Preferably, each radial guidance extends along a line, wherein preferably all lines are in a plane and intersect in one point through which preferably the rotational axis of the longitudinal rod guidance passes, wherein the rotational axis is preferably perpendicular to the plane. All drives are preferably electrical drives. Preferably, the device furthermore includes a wire guidance arrangement, a longitudinal wire clamping arrangement and a welding arrangement. The longitudinal wire clamping arrangement clamps the longitudinal rods at an end so that they may be pulled through the longitudinal rod guidance arrangement due to a relative linear translation of the longitudinal wire clamping arrangement in respect to the longitudinal rod guidance arrangement. Preferably, the longitudinal wire clamping arrangement is rotatable around an axis which is identical to the rotational axis of the longitudinal rod guidance arrangement. When producing reinforcement cages, the rotations of the longitudinal rod guidance arrangement and of the longitudinal wire clamping arrangement are preferably synchronized by a controller. The longitudinal wire clamping arrangement is preferably provided on a moving arrangement, preferably on a clamping arrangement carriage. The relative linear translation of the longitudinal wire clamping arrangement in respect to the longitudinal rod guidance arrangement is caused by moving the clamping arrangement carriage. The wire guidance arrangement provides for the helical positioning of the wire on the longitudinal rods while these are pulled through the longitudinal rod guidance arrangement. The welding arrangement is provided on a moving arrangement, preferably a welding arrangement carriage. The welding arrangement welds the wires to the longitudinal rods. The longitudinal wire clamping arrangement, the wire guidance arrangement, and the welding arrangement are substantially known from the state of the art and therefore a detailed description is not required. All of the drives and the welding arrangement are controlled by a controller. Detectors may be present so as to detect the positions of all of the movable components of the device for producing reinforcement cages and to feed them back to the controller. Advantageously, the device allows to produce a reinforcement cage including a portion having a not round, in particular elliptical, cross-section, which is ideal for a cylindrical tube portion, and a portion having a round cross-section, which is ideal for a sleeve extension. In general, both the diameter and the shape of the reinforcement cage can be varied.

In a preferred embodiment, the guidance element drives are preferably implemented as spindle drives. The spindles are preferably mounted rotatably to the longitudinal rod guidance arrangement. Preferably, the spindle drives are fixed to the longitudinal rod guidance arrangement. Advantageously, this facilitates the implementation of the current supply for the spindle drives and allows to provide it in an outer area of the longitudinal rod guidance arrangement where there is sufficient space.

In a further development of the preferred embodiment, the spindle drives are provided at an outer end of the associated (at least one) spindle, respectively. In the context of the present invention, an outer end of a spindle is the end of a spindle which faces away from the center of the longitudinal rod guidance arrangement (through which for example a rotational axis of the longitudinal rod guidance arrangement passes). In the context of the present invention “the spindle drive is provided at an outer end of the associated (at least one) spindle” preferably means that a drive element of the spindle drive which acts on the associated (at least one) spindle and by this transfers a movement to the associated (at least one) spindle is arranged closer to the outer end of the associated (at least one) spindle than to the other (inner) end of the associated (at least one) spindle, and/or that the distance between the drive element of the spindle drive and the outer end of the associated (at least one) spindle is at most 60 cm, more preferably at most 30 cm, more preferably at most 10 cm. Preferably, the drive element and the outer end of the associated (at least one) spindle are connected to each other rotationally fixed and include a shared rotational axis. Advantageously, the spindle drives can be provided in an outer area of the longitudinal rod guidance arrangement and in immediate proximity to current supply conductors and/or signal conductors which include, for example, one or more slip rings so that long current cables are not required at the longitudinal rod guidance arrangement.

In yet another preferred embodiment, each spindle passes through a spindle nut which is mounted rotationally fixed to the respective guidance element. In the context of the present invention, a spindle nut is always a threaded spindle nut. Preferably, for each spindle a guidance element drive is provided which is implemented as spindle drive, wherein the spindle drive is configured to drive an associated spindle, respectively. The spindles which belong to the same guidance element can also include a shared spindle drive.

In a further development of the last mentioned preferred embodiment, each spindle nut is connected to the respective guidance element via a rotational bearing, and for each spindle nut a guidance element drive is provided by means of a spindle nut drive so as to drive the respective spindle nut. The spindle nuts which belong to the same guidance element can also include a shared spindle nut drive. Preferably, the spindles are provided rotationally fixed to the longitudinal rod guidance arrangement.

In yet another further development of the last mentioned preferred embodiment, the spindles are rotationally supported and a central spindle drive is provided so as to synchronously drive the spindles. Preferably, a force transfer from the central spindle drive to a spindle occurs via a gear, respectively.

In yet another preferred embodiment, a further spindle is provided for each guidance element. The spindle and the further spindle which belong to the same radial guidance can include a shared spindle drive or two different spindle drives.

In a further development of the last mentioned preferred embodiment, each further spindle passes through a further spindle nut which is mounted rotationally fixed to the respective guidance element.

In yet a further development of the preferred embodiment, each further spindle nut is connected to the respective guidance element via a further rotational bearing, and each further spindle nut is drivable by the spindle nut drive which is configured to additionally drive the spindle nut of the respective guidance element. In the alternative, the further spindle nut can be drivable by a further spindle drive.

In yet a further preferred embodiment, each spindle drive is an electrical spindle drive and the current supply to each spindle drive comprises one or more slip rings. The slip ring is contacted by a respective slip contact. Preferably, each current supply can comprise two slip rings (one slip ring for one polarity, respectively). Preferably, the current supplies for different spindle drives can comprise one or more shared slip rings. Preferably, the slip ring runs around the longitudinal rod guidance arrangement, and preferably the respective slip contact is provided at a frame which surrounds the longitudinal rod guidance arrangement. Preferably, for each spindle drive at least one signal conductor for control signals is provided which also comprises one or more slip rings. This slip ring is contacted by a corresponding slip contact as well. Preferably, the signal conductors can comprise one or more shared slip rings for different spindle drives. Preferably, each slip ring surrounds the longitudinal rod guidance arrangement, wherein the rotational axis of the longitudinal rod guidance arrangement passes through the center of the slip ring. Preferably, the slip rings are provided on a frame which surrounds the longitudinal rod guidance arrangement.

In a yet a more general, preferred embodiment, each guidance element drive is an electric drive, and the current supply to each guidance element drive comprises one or more slip rings. The guidance element drive is preferably implemented either as spindle drive or as spindle nut drive. The slip ring is contacted by a corresponding slip contact. Preferably, each current supply can comprise two slip rings (one slip ring for one polarity, respectively). Preferably, the current supplies for different drives can comprise one or more shared slip rings. Preferably, the slip ring runs around the longitudinal rod guidance arrangement, and the respective slip contact is provided at a frame which surrounds the longitudinal rod guidance arrangement. Preferably, for each drive at least one signal conductor for control signals is provided which also comprises one or more slip rings. This slip ring is contacted by a corresponding slip contact as well. Preferably, the signal conductors for different drives can comprise one or more shared slip rings. Preferably, each slip ring surrounds the longitudinal rod guidance arrangement, wherein the rotational axis of the longitudinal rod guidance arrangement passes through the center of the slip ring. Preferably, the slip rings are provided on a frame which surrounds the longitudinal rod guidance arrangement.

According to the invention, all embodiments, further developments and optional features can be combined with each other in any manner, as long as this is not excluded.

The present invention further relates to a longitudinal rod guidance arrangement having multiple guidance elements and multiple radial guidances so as to guide one of the guidance elements each, for a device for producing reinforcement cages having multiple longitudinal rods around which a wire, being welded to the longitudinal rods, preferably helically, runs, in particular for concrete tubes, wherein the radial guidances each comprise a spindle arrangement having at least one spindle, wherein at least two guidance element drives are provided which are configured to move one of the guidance elements each independently along the associated radial guidance. The longitudinal rod guidance arrangement can include all features or feature combinations which have been described in context with the embodiments and further developments of the device for producing reinforcement cages.

### BRIEF DESCRIPTION OF THE DRAWINGS

The accompanying figures, which are incorporated in and form a part of this specification, illustrate embodiments of the invention and, together with the description given above and the detailed description of the preferred embodiments given below, serve to explain the principles of the invention. In the following, the invention is described with reference to the drawings in more detail, in which:

FIG. 1A shows a perspective view of a device for producing reinforcement cages;

FIG. 1B shows a perspective detail view which illustrates the longitudinal rod guidance arrangement;

FIG. 2A shows a front view of the longitudinal rod guidance arrangement;

FIG. 2B shows a cut view of the longitudinal rod guidance arrangement along the A-A line from FIG. 2A;

FIG. 2C shows a back view of the longitudinal rod guidance arrangement;

FIG. 3A shows a schematic view of a first embodiment of a spindle arrangement;

FIG. 3B shows a schematic view of a second embodiment of a spindle arrangement;

FIG. 3C shows a schematic view of a third embodiment of a spindle arrangement;

FIG. 3D shows a schematic view of a fourth embodiment of a spindle arrangement;

FIG. 3E shows a schematic view of a fifth embodiment of a spindle arrangement;

FIG. 3F shows a schematic view of a sixth embodiment of a spindle arrangement; and

FIG. 3G shows a schematic view of a seventh embodiment of a spindle arrangement.

### DETAILED DESCRIPTION OF THE PREFERRED EMBODIMENTS

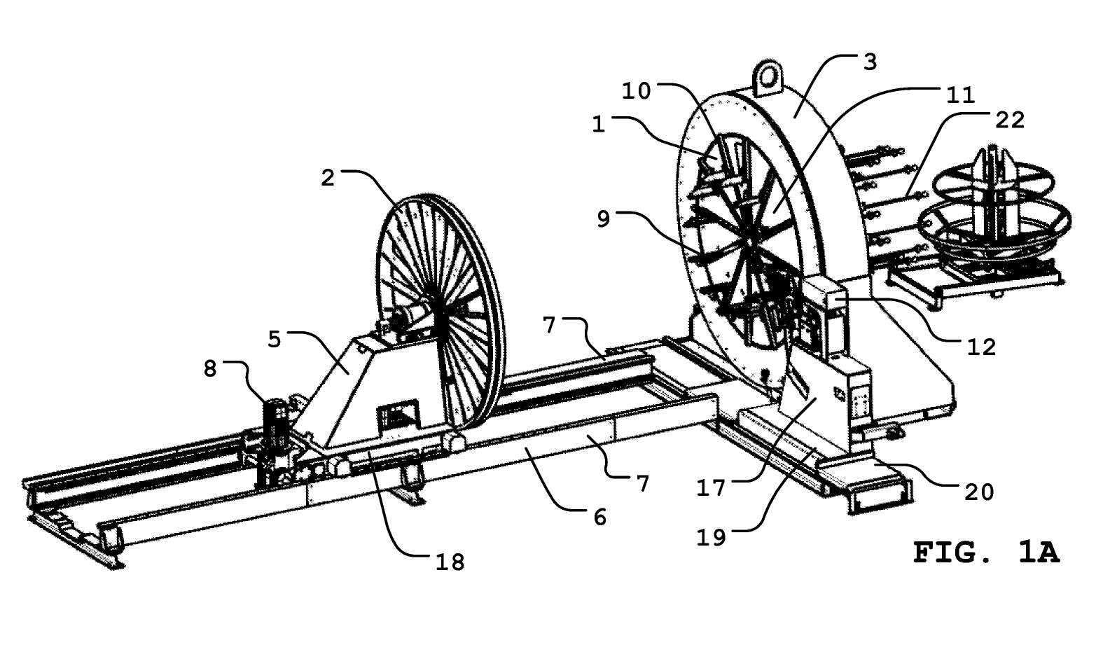

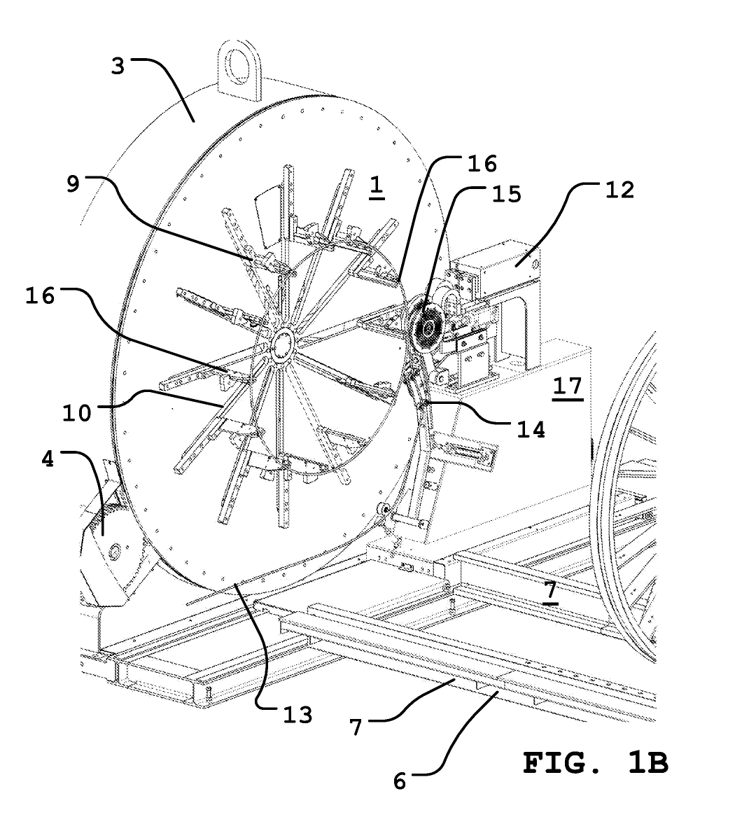

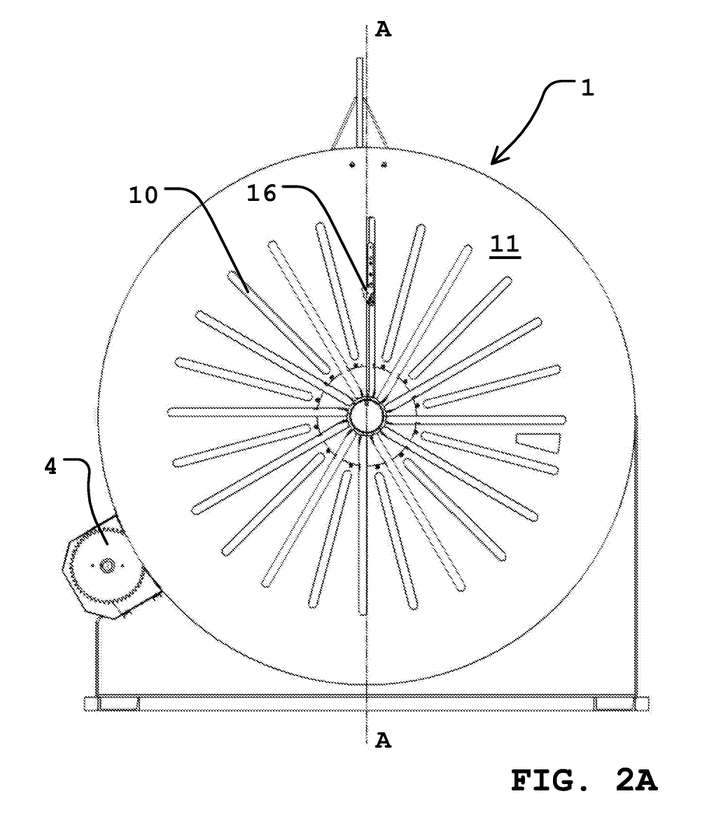

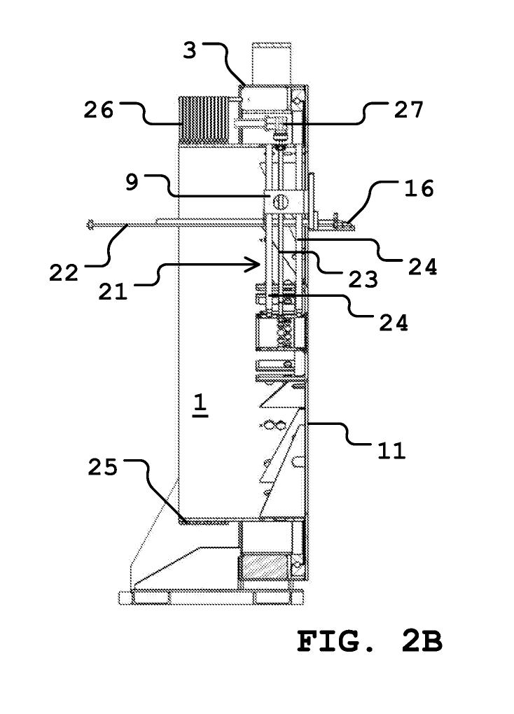

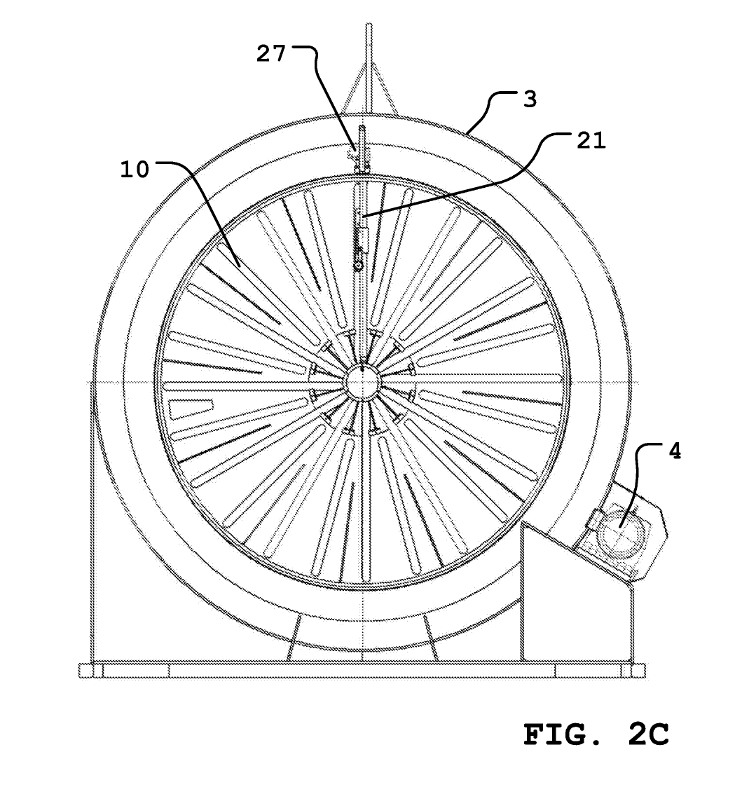

FIG. 1A shows a perspective view of a device for producing reinforcement cages. FIG. 1B shows a perspective detail view which illustrates the longitudinal rod guidance arrangement from FIG. 1B. The device for producing reinforcement cages comprises a rotatable longitudinal rod guidance arrangement 1 and a rotatable longitudinal rod clamping arrangement 2. The longitudinal rod guidance arrangement 1 and the longitudinal rod clamping arrangement 2 have a shared rotational axis. The longitudinal rod guidance arrangement 1 is accommodated in a cylindrical frame 3. A longitudinal rod guidance arrangement drive 4 is configured to rotate the longitudinal rod guidance arrangement 1 around its rotational axis. A longitudinal rod clamping arrangement drive 5 is configured to rotate the longitudinal rod guidance arrangement 2 around its rotational axis. The longitudinal rod guidance arrangement 1 and the longitudinal rod clamping arrangement 2 are movable relative to each other along their shared rotational axis. The longitudinal rod clamping arrangement 2 is provided on a clamping arrangement carriage 18. The clamping arrangement carriage 18 is movable along the shared rotational axis of the longitudinal rod guidance arrangement 1 and the longitudinal rod clamping arrangement 2 on an axial guidance 6 having two opposing rails 7, wherein the longitudinal rod clamping arrangement 2 is driven by a clamping arrangement carriage drive 8. The longitudinal rod guidance arrangement 1 comprises multiple radially movable guidance elements 9 (for illustrational purposes, here twelve guidance elements are depicted. Actually, many more guidance elements may be present, for example 24.) which each pass through a radial slit 10 in a bezel 11 and are drivable along a radial guidance by a guidance element drive (see FIG. 2A). A welding arrangement 12 is provided on a welding arrangement carriage 19 which is movable transversally in respect to the shared rotational axis on a transversal guide 20, wherein the welding arrangement carriage 19 is driven by a welding arrangement drive 17. A wire 13 is guided by a wire guidance arrangement 14 which is provided at the welding arrangement 12. The welding arrangement 12 comprises a welding electrode 15. A corresponding counter welding electrode 16 is implemented on the guidance elements 9, respectively.

FIG. 2A shows a front view of the longitudinal rod guidance arrangement. FIG. 2B shows a cut view of the longitudinal rod guidance arrangement 1 along the A-A line from FIG. 2A. FIG. 2C shows a rear view of the longitudinal rod guidance arrangement 1. In FIG. 2A, FIG. 2B and FIG. 2C, for clarity purposes, only one radial guidance 21 of the multiple radial guidances and one of the guidance elements 9 of the multiple guidance elements, each being in formation along one of the radial slits 10 in the bezel 11 and having an associated guidance element drive 27, are shown. The radial guidances 21 and guidance elements 9 are substantially identical or implemented identically and are only arranged in another manner (angularly offset). The radial guidances 21 each include a rotatable spindle 23 and two guidance columns 24. The rotatable spindle 23 passes through the guidance element 9 and a spindle nut which is mounted rotationally fixed on the guidance element 9. The guidance columns 24 also pass through the bores in the guidance element 9. Each guidance element 9 includes a guidance tube 22 through which a longitudinal rod is passed, respectively. At the front end of the guidance pipe 22, a counter welding electrode 16 is provided with which a longitudinal rod being passed through the guidance tube 22 is in touch, respectively. Laterally, adjacent to the longitudinal rod guidance arrangement 1, a longitudinal rod guidance arrangement drive 4 is provided which rotates the longitudinal rod guidance arrangement 1 in a cylindrical frame 3 around its rotational axis. The longitudinal rod guidance arrangement 1 includes multiple slip rings 25 extending around the longitudinal guidance arrangement 1 and being part of the current supply or of signal conductors of the guidance element drives 27. These slip rings 25 are contacted by associated slip contacts which are provided on the cylindrical frame 3. The signal conductors and current supply conductors and their electrical connections to the slip rings 25, the slip contacts 26 and the guidance element drives 27 are not depicted as they are obvious for the person skilled in the art and they would render the illustration confusing.

During production of reinforcement cages, longitudinal rods are passed through the guidance tubes 22 of the guidance elements 9 and clamped in a clamping arrangement (not shown) of the longitudinal rod clamping arrangement 2, respectively. The longitudinal rod clamping arrangement 2 is then moved on the clamping arrangement carriage 18 along the shared rotational axis of the longitudinal rod guidance arrangement 1 and of the longitudinal rod clamping arrangement 2. Following this, the longitudinal rod guidance arrangement 1 and the longitudinal rod clamping arrangement 2 are turned synchronously by the same angle which corresponds to the angular distance between two longitudinal rods. Then, the guidance elements 9 can be moved radially. The welding arrangement carriage 19 is moved so that it is in the suitable position for the welding process of the welding arrangement 12. During the welding, the welding electrode 15 pushes the wire 14 and one of the longitudinal rods (not shown) against one of the counter welding electrodes 16. Then, the welding process is performed and the production method continues from the moving of the clamping arrangement carriage 18 along the shared rotational axis of the longitudinal rod guidance arrangement 1 and of the longitudinal rod clamping arrangement 2, as described, until the end of the production. The longitudinal rod guidance arrangement 4, the longitudinal rod clamping arrangement drive 5, the moving arrangement drive 8, the welding arrangement drive 17, the welding arrangement 12, and the guidance element drives are controlled by a central controller (not shown). Current supply conductors and control conductors are not shown or not shown completely in the figures either so as to prevent confusion.

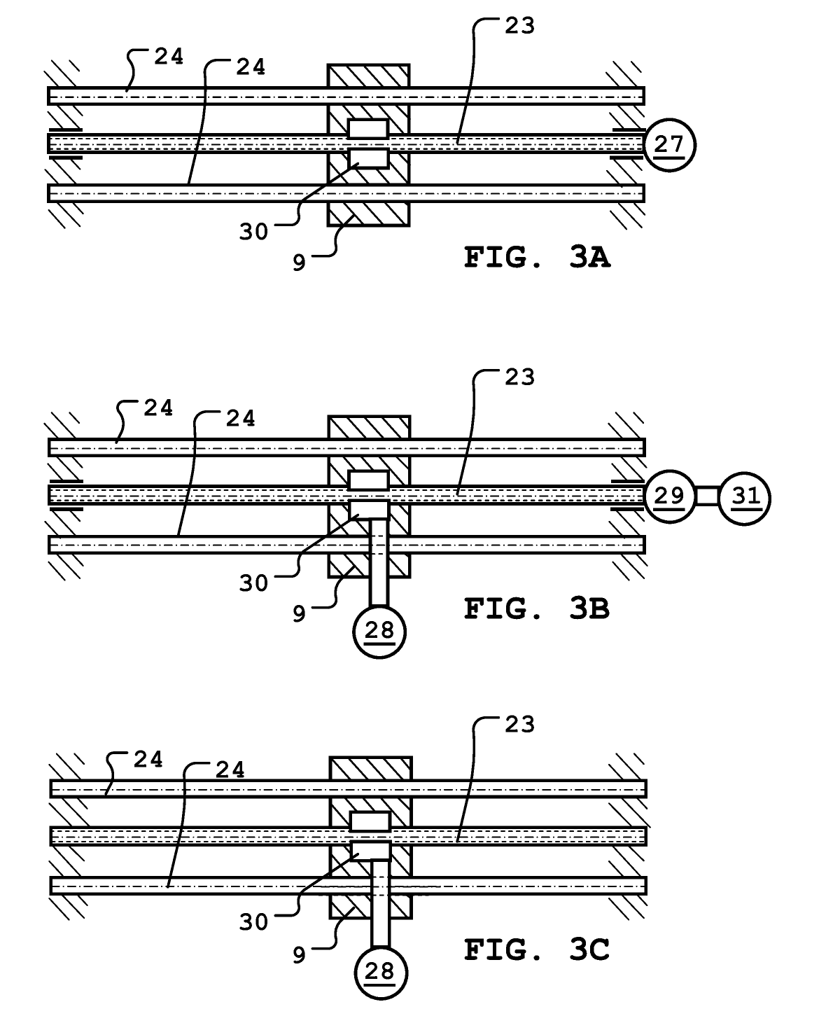

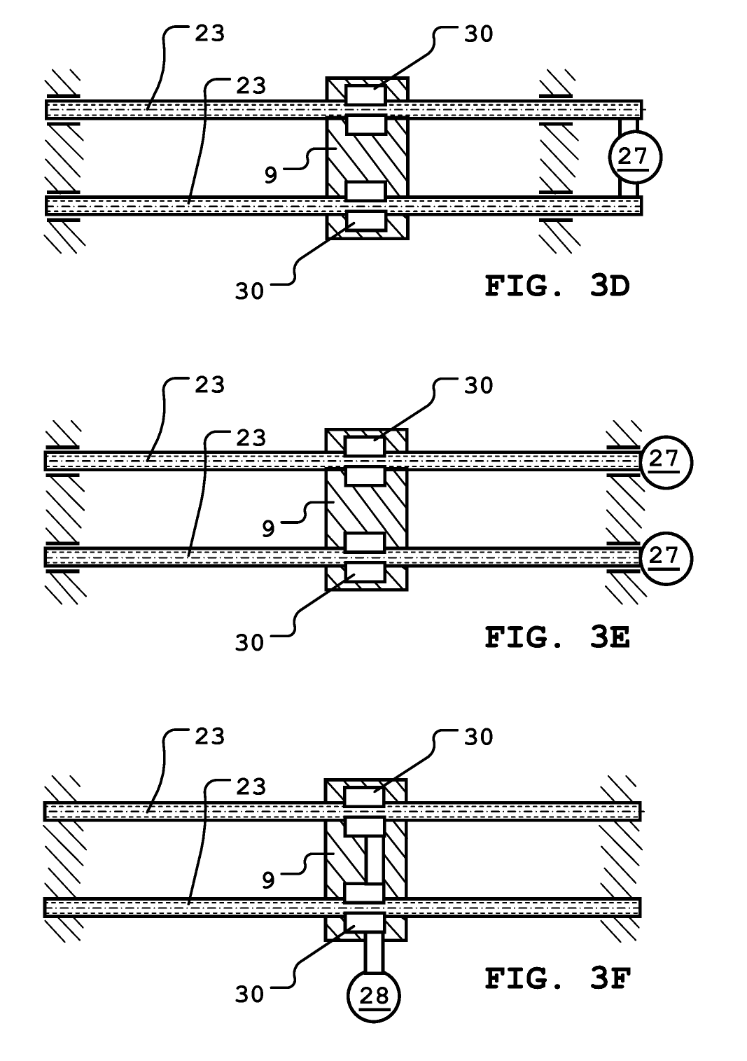

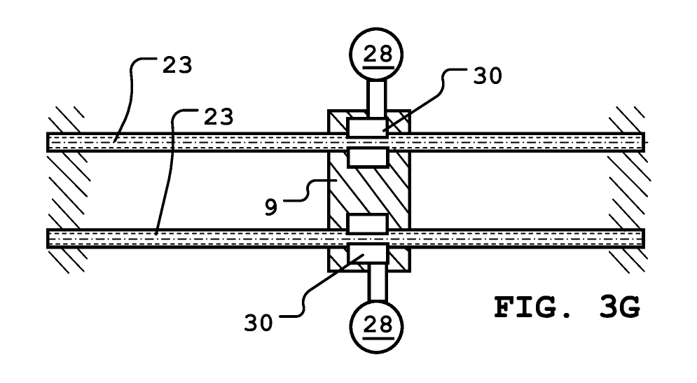

In the FIGS. 3A to 3G, different embodiments of a radial guidance are schematically shown. Elements having the same function are referenced to with the same reference numeral.

FIG. 3A shows a schematic view of a first embodiment of a radial guidance. The radial guidance comprises a spindle 23 which is mounted rotatably and passes through a spindle nut 30. The spindle 23 is driven by a spindle drive 27. The spindle nut 30 is mounted rotatably fixed to the guidance element 9. A respective guidance column 24 is provided on two opposite sides of the spindle 23. The first embodiment corresponds to the embodiment depicted in the previous figures.

FIG. 3B shows a schematic view of a second embodiment of a radial guidance. The radial guidance comprises a spindle 23 which is mounted rotatably and passes through a spindle nut 30. The spindle 23 is driven by a central spindle drive 31 via a gear 29. Via the gear 29, at the same time, the spindles of the further radial guidances are driven synchronously by the central spindle drive 31. The spindle nut 30 is mounted rotatably to the guidance element 9. The spindle nut 30 is driven by a spindle nut drive 28. This allows to move the guidance elements 9 radially by a different amount while they are moved radially by the spindle drive 27 by the same amount. A respective guidance column 24 is provided on two opposing sides of the spindle.

FIG. 3C shows a schematic view of a third embodiment of a third radial guidance. The radial guidance comprises a spindle 23 which is mounted rotatably fixed and passes through a spindle nut 30. The spindle nut 30 is mounted rotatably to the guidance element 9. The spindle nut 30 is driven by a spindle nut drive 28. A respective guidance column 24 is provided on two opposite sides of the spindle.

FIG. 3D shows a schematic view of a fourth embodiment of a radial guidance. The radial guidance comprises two spindles 23 which are each mounted rotatably and pass through a spindle nut 30. Both spindles 23 are driven by the same spindle drive 27. The spindle nuts 30 are mounted rotatably fixed to the guidance element 9.

FIG. 3E shows a schematic view of a fifth embodiment of a radial guidance. The radial guidance comprises two spindles 23 which are each mounted rotatably and pass through a spindle nut 30. Both spindles 23 are driven by two different spindle drives 27. The spindle nuts 30 are mounted rotatably fixed to the guidance element 9.

FIG. 3F shows a schematic view of a sixth embodiment of a radial guidance. The radial guidance comprises two spindles 23 which are mounted rotatably fixed and each pass through a spindle nut 30. The spindle nuts 30 are mounted rotatably to the guidance element 9. The spindle nuts 30 are driven by a spindle nut drive 28.

FIG. 3G shows a schematic view of a seventh embodiment of a radial guidance. The radial guidance comprises two spindles 23 which are mounted rotatably fixed and each pass through a spindle nut 30. The spindle nuts 30 are mounted rotatably to the guidance element 9. The spindle nuts 30 each are driven by a spindle nut drive 28.

Thus, it will be seen that the improvements presented herein are consistent with the objects of the invention described above. While the above description contains many specificities, these should not be construed as limitations on the scope of the invention, but rather as exemplifications of preferred embodiments thereof. Many other variations are within the scope of the present invention. Accordingly, it is intended that the scope of the invention is determined not by the embodiments illustrated or the physical analyses motivating the illustrated embodiments, but, rather, by the appended claims and their legal equivalents.

### LIST OF REFERENCE NUMERALS

longitudinal rod guidance arrangement 1

longitudinal rod clamping arrangement 2

cylindrical frame 3

longitudinal rod guidance arrangement drive 4

longitudinal rod clamping arrangement drive 5

axial guidance 6

rails 7

clamping arrangement carriage drive 8

guidance element 9

radial slit 10

bezel 11

welding arrangement 12

wire 13

wire guidance arrangement 14

welding electrode 15

counter welding electrode 16

welding arrangement drive 17

clamping arrangement carriage 18

welding arrangement carriage 19

transversal guidance 20

radial guidance 21

guidance tube 22

spindle 23

guidance column 24

slip ring 25

slip contact 26

spindle drive 27

spindle nut drive 28

gear 29

spindle nut 30

central spindle drive 31

What is claimed is:

1. A device for producing reinforcement cages comprising multiple longitudinal rods around which a wire, being welded to the longitudinal rods, runs, the device including a longitudinal rod guidance arrangement having multiple guidance elements and multiple radial guidances, each of said multiple radial guidances guiding one of said multiple guidance elements, each of said multiple radial guidances including a spindle arrangement having at least one spindle, further including at least two guidance element drives, each of said at least two guidance element drives being configured to move one of said multiple guidance elements independently along the associated one of said multiple radial guidances, wherein said guidance element drives are implemented as spindle drives, and wherein each spindle drive is an electrical spindle drive, and a current supply for each spindle drive comprises one or more slip rings.

2. The device of claim 1 wherein each of said spindle drives is provided at an outer end of an associated one of said spindles.

3. The device of claim 1 wherein each said spindle passes through a spindle nut which is mounted rotationally fixed to an associated one of said guidance elements.

4. The device of claim 3 wherein each said spindle nut is connected to an associated one of said guidance elements via a rotational bearing, and for each of said spindle nuts a guidance element drive is implemented as an associated spindle nut drive so as to drive the associated spindle nut.

5. The device of claim 4 wherein said spindles are rotationally supported, and a central spindle drive is provided so as to synchronously drive the spindles.

6. The device of claim 1 wherein an additional spindle is provided for each of said guidance elements.

7. The device of claim 2 wherein an additional spindle is provided for each of said guidance elements.

8. The device of claim 3 wherein an additional spindle is provided for each of said guidance elements.

9. The device of claim 4 wherein an additional spindle is provided for each of said guidance elements.

10. The device of claim 6 wherein each of said additional spindles passes through an associated additional spindle nut which is mounted rotationally fixed to an associated one of said guidance elements.

11. The device of claim 7 wherein each of said additional spindles passes through an associated additional spindle nut which is mounted rotationally fixed to an associated one of said guidance elements.

12. The device of claim 8 wherein each of said additional spindles passes through an associated additional spindle nut which is mounted rotationally fixed to an associated one of said guidance elements.

13. The device of claim 9 wherein each of said additional spindles passes through an associated additional spindle nut which is mounted rotationally fixed to an associated one of said guidance elements.

14. The device of claim 10 wherein each of said additional spindles passes through an associated additional spindle nut which is mounted rotationally fixed to an associated one of said guidance elements.

15. The device of claim 11 wherein each of said additional spindles passes through an associated additional spindle nut which is mounted rotationally fixed to an associated one of said guidance elements.

16. The device of claim 4 wherein an additional spindle and an additional spindle nut is provided for each of said guidance elements, each of said additional spindle nuts is connected to an associated one of said guidance elements via an additional rotational bearing, and each of said additional spindle nuts is drivable by a spindle nut drive which is configured to additionally drive the associated one of said spindle nuts of the associated one of said guidance elements.

17. The device of claim 5 wherein an additional spindle and an additional spindle nut is provided for each of said guidance elements, each of said additional spindle nuts is connected to an associated one of said guidance elements via an additional rotational bearing, and each of said additional spindle nuts is drivable by a spindle nut drive which is configured to additionally drive the associated one of said spindle nuts of the associated one of said guidance elements.

18. A device for producing reinforcement cages having a longitudinal rod guidance arrangement around which a wire, being welded to the longitudinal rods, runs, comprising: multiple guidance elements and multiple radial guidances, each of said multiple radial guidances guiding one of said multiple guidance elements, each of said radial guidances including a spindle arrangement having at least one spindle, and at least two guidance element drives being provided which are configured to move one of said guidance elements independently along an associated one of said radial guidances.
